(19) United States
(12) Patent Application Publication
(10) Pub. No.: US 2026/0121759 A1
(43) Pub. Date: Apr. 30, 2026

(54) METHOD AND DEVICE FOR INHOMOGENEOUS POLARIZATION MODULATION

(71) Applicant: LG Electronics Inc., Seoul (KR)

(72) Inventors: Hojae LEE, Seoul (KR); Sangrim LEE, Seoul (KR); Ja Yeong KIM, Seoul (KR); Byungkyu AHN, Seoul (KR)

(21) Appl. No.: 19/118,493

(22) PCT Filed: Oct. 6, 2022
(86) PCT No.: PCT/KR2022/015039

§ 371 Date: Apr. 4, 2025

(51) Int. Cl. H04B 10/532; H04B 10/67; H04B 10/69

(52) U.S. Cl. CPC H04B 10/532; H04B 10/67; H04B 10/69

(57) ABSTRACT

A method and a device used in an optical wireless communication (OWC) system are provided. A transmission terminal generates multiple inhomogeneous polarization patterns on the basis of polarization superposition. In addition, the transmission terminal maps a modulation state and an information bit for each of the multiple inhomogeneous polarization patterns, modulates a signal on the basis of one inhomogeneous polarization pattern among the multiple inhomogeneous polarization patterns, and transmits the modulated signal A reception terminal receives a modulated signal, and determines one inhomogeneous polarization pattern among the multiple inhomogeneous polarization patterns on the basis of polarization measurement for the modulated signal. The reception terminal determines an information bit mapped to the one inhomogeneous polarization pattern, and demodulates the modulated signal on the basis of a modulation state mapped to the information bit.

### TECHNICAL FIELD

The present disclosure relates to a method and apparatus for use in Optical Wireless Communication (OWC) systems.

### BACKGROUND ART

With the commercialization of New Radio (NR), the fifth generation (5G) mobile communications technology, research into sixth generation (6G) mobile communications technology is beginning. It is expected that 6th generation mobile communication technology will utilize frequency bands above 100 GHz. This is expected to increase the number of utilized frequencies by more than 10 times compared to 5G, and allow for greater utilization of spatial resources. Electromagnetic waves in the radio frequency band have been widely used as a resource for wireless communication technology. To date, the vast amounts of wireless communication traffic required by advancing communication generations have been handled by increasing the available radio frequency bands or reducing the size of the cells covered by base stations. However, the development of wireless communication technology in the radio frequency band is becoming increasingly challenging due to the limitations of electronic devices as the frequency increases to tens of GHz and beyond, and the need for advanced beamforming technology due to the increasing straightness of the carrier.

### DISCLOSURE

### Technical Problem

Optical Wireless Communication (OWC) may be a good alternative for organizing future mobile communication systems. OWC has the advantage of using ultra-wideband optical frequency resources, which are free from frequency allocation regulations, and of using fiber-based ultra-high speed communication system technologies that are already quite mature. The beamforming technology that is currently being actively researched and developed is also expected to be easy to apply, as it is not fundamentally different from the beam alignment technology used in mobile wireless optical communication systems.

In an environment where fine beams are transmitted, there is a high probability that the link formed between the transmitting end and receiving end is a single path. Therefore, a high channel gain through a single path can be expected, but it is difficult to expect the spatial diversity of a Multiple-Input Multiple-Output (MIMO) multi-antenna transmission and reception system. Therefore, in order to maximize the data rate when a high channel gain of a single path is guaranteed, an increase in spectral efficiency through a high modulation order is required.

### Technical Solution

In an aspect, a method performed by a transmitting end in a wireless communication system is provided. The method comprises, generating a plurality of inhomogeneous polarization patterns based on superposition of polarization, mapping a modulation state and an information bit for each of the plurality of inhomogeneous polarization patterns, modulating a signal based on one inhomogeneous polarization pattern from among the plurality of inhomogeneous polarization patterns, and transmitting the modulated signal to a receiving end.

In another aspect, a method performed by a receiving end in a wireless communication system is provided. The method comprises, receiving a modulated signal from a transmitting end, determining one inhomogeneous polarization pattern from among a plurality of inhomogeneous polarization patterns based on a polarization measurement of the modulated signal, determining an information bit mapped to the one inhomogeneous polarization pattern, and demodulating the modulated signal based on a modulation state mapped to the information bit.

In another aspect, an apparatus implementing the above method is provided.

### Advantageous Effects

The present disclosure can have various advantageous effects. For example, a novel modulation scheme can be provided that utilizes wavefront spatial characteristics in LOS OWC environments utilizing narrow beams.

For example, by utilizing spatial dimensions in LOS environments, the data rate of communications can be increased.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of a wireless device to which implementations of the present disclosure are applied.

FIG. 4 shows an example of UE to which implementations of the present disclosure are applied.

FIG. 5 shows an example of beam formation in a mobile OWC to which implementations of the present disclosure are applied.

FIG. 6 shows an example of inhomogeneous beam formation to which implementations of the present disclosure are applied.

FIG. 7 shows a method performed by a transmitting end to which implementations of the present disclosure are applied.

FIG. 8 shows a method performed by a receiving end to which implementations of the present disclosure are applied.

FIG. 9 is an example of each IP pattern matrix for 4-IPM to which the first implementation of the present disclosure is applied.

FIG. 10 shows an example of a structure of a transmitter to which the second implementation of the present disclosure is applied.

FIG. 11 shows an example of a detailed structure of an inhomogeneous polarization modulator in an optical signal processor to which the second implementation of the present disclosure is applied.

FIG. 12 shows an example of a structure of a receiver to which the second implementation of the present disclosure is applied.

FIG. 13 shows an example of a detailed structure of a polarization state detector to which the second implementation of the present disclosure is applied.

FIG. 14 shows another example of a detailed structure of a polarization state detector to which the second implementation of the present disclosure is applied.

FIG. 15 shows an example of a coherent detector to which the second implementation of the present disclosure is applied.

FIG. 16 shows another example of a coherent detector to which the second implementation of the present disclosure is applied.

FIG. 17 shows an example of a 3 dB coupler and a balanced PD to which the second implementation of the present disclosure is applied.

FIG. 18 shows an example of demodulating an adjusted or rotated IP pattern to which the second implementation of the present disclosure is applied.

FIG. 19 shows an example of acquiring an inhomogeneous polarization pattern based on difference information to which the third implementation of the present disclosure is applied.

### MODE FOR INVENTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

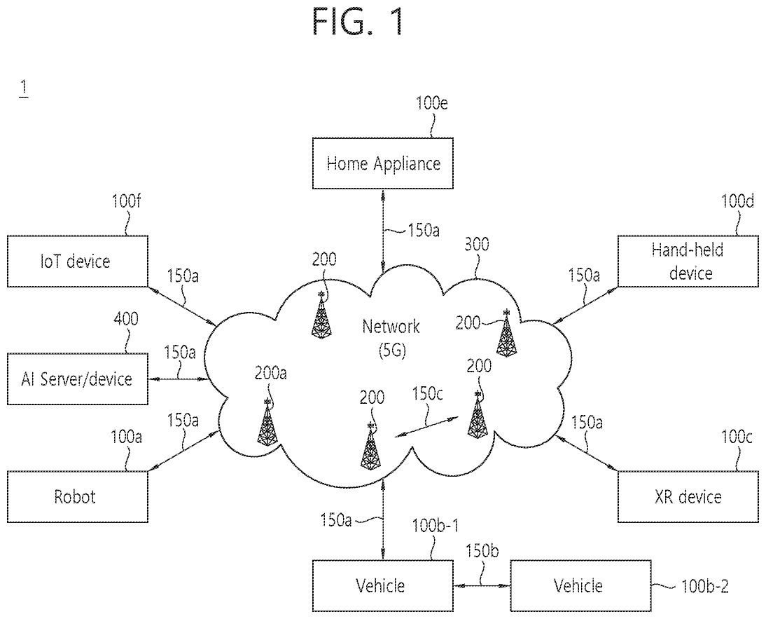

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a. 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 1001 may transmit/receive radio signals to/from each other through the wireless communication/connections 150a, 150b and 150c. For example, the wireless communication/connections 150a. 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency | Corresponding | Subcarrier |
|---|---|---|
| Range designation | frequency range | Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

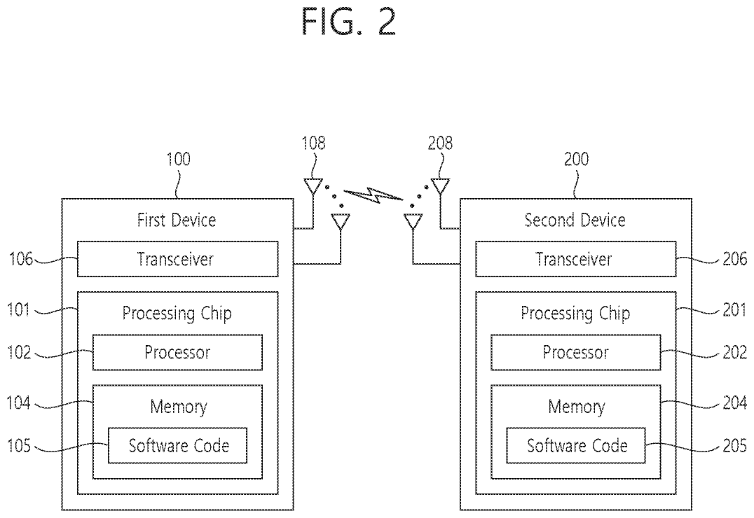

FIG. 2 shows an example of wireless devices to which implementations of the present disclosure are applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200) may correspond to at least one of (the wireless device 100a to 100f and the BS 200), (the wireless device 100a to 100f and the wireless device 100a to 100f} and/or {the BS 200 and the BS 200) of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, w % ben executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs) and/or one or more Service Data Units (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable ROMs (EEPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a Node B (NB), an eNode B (eNB), or a gNB.

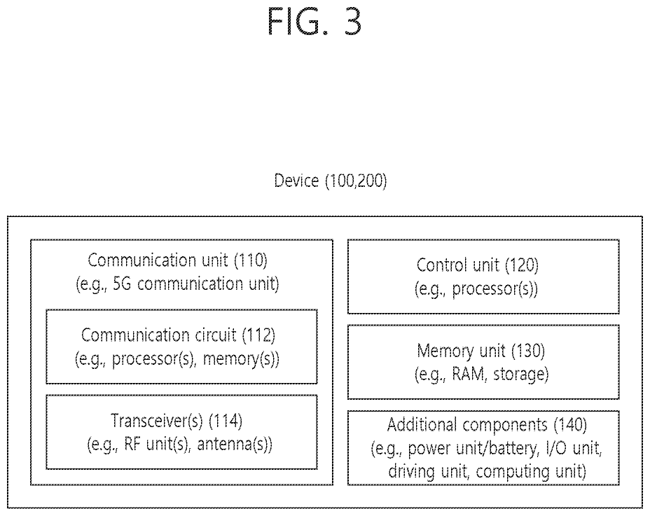

FIG. 3 shows an example of a wireless device to which implementations of the present disclosure are applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, Input/Output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an Application Processor (AP), an Electronic Control Unit (ECU), a Central Processing Unit (CPU), a Graphical Processing Unit (GPU), and a memory control processor. As another example, the memory unit 130 may be configured by a RAM, a Dynamic RAM (DRAM), a ROM, a flash memory, a volatile memory, a non-volatile memory, and/or a combination thereof.

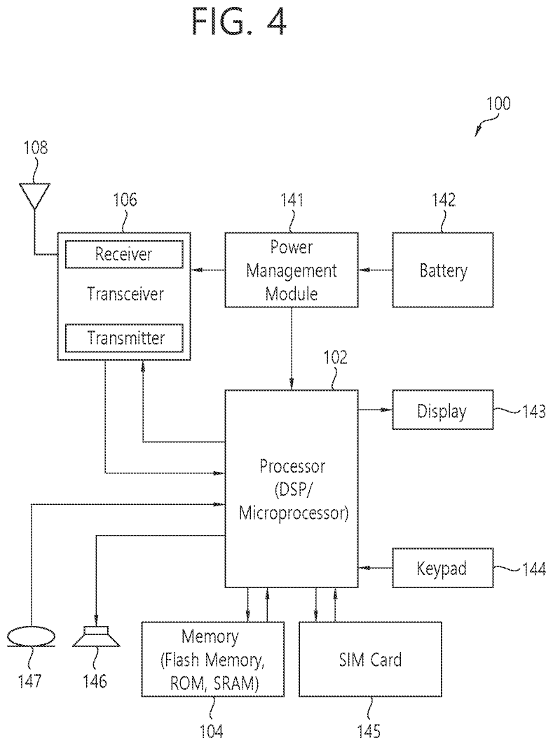

FIG. 4 shows an example of UE to which implementations of the present disclosure are applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm*, EXYNOS™ series of processors made by Samsung®, A series of processors made by Apple®, HELIOT™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

The 6G wireless communication system (hereinafter referred to simply as 6G) aims to enable (i) very high data rates per device, (ii) a very large number of connected devices, (iii) global connectivity, (iv) very low latency, (v) reduced energy consumption for battery-free IoT devices, (vi) ultra-reliable connectivity, and (vii) connected intelligence with machine learning capabilities. 6G may include four aspects: intelligent connectivity, deep connectivity, holographic connectivity, and ubiquitous connectivity. In addition to 5G's main categories of eMBB. URLLC, and mMTC, 6G may also include AI integrated communication, tactile internet, high throughput, high network capacity, high energy efficiency, low backhaul and access network congestion, and enhanced data security as key factors.

As part of the core technology for 6G, Optical Wireless Communication (OWC) may be used. OWC is already in use since 4G, but is expected to be more widely used to meet the requirements of 6G. In addition to RF-based communication for all device-to-access networks possible in 6G, OWC may be applied for network-to-backhaul/fronthaul network connections. OWC-related technologies such as light fidelity, visible light communication, optical camera communication, and FSO communication based on optical bands are already well known. OWC-based communication may provide very high data rates, low latency, and secure communication. In addition, in 6G, Light Detection And Ranging (LiDAR) may be utilized for ultra-high resolution 3D mapping based on the optical band.

Hereinafter, the following symbols/abbreviations/terms are used in the present disclosure.
OF: Optical Frequency
OWC: Optical Wireless Communication
NLOS: Non-Line of Sight
DSP: Digital Signal Processor
HP: Horizontal Polarization
VP: Vertical Polarization
RCP: Right-hand Circular Polarization
LCP: Left-hand Circular Polarization
REP: Right-hand Elliptical Polarization
LEP: Left-hand Elliptical Polarization
LG: Laguerre Gaussian
HG: Hermite Gaussian
TIA: Transimpedance Amplifier

Unlike RF communications in 3GPP LTE or NR, OWCs may use very small beamwidths. By controlling beam divergence through a separate technology and implementing beam Pointing Acquisition Tracking (PAT), most of the beams generated/transmitted by the transmitting can be received by the receiving end.

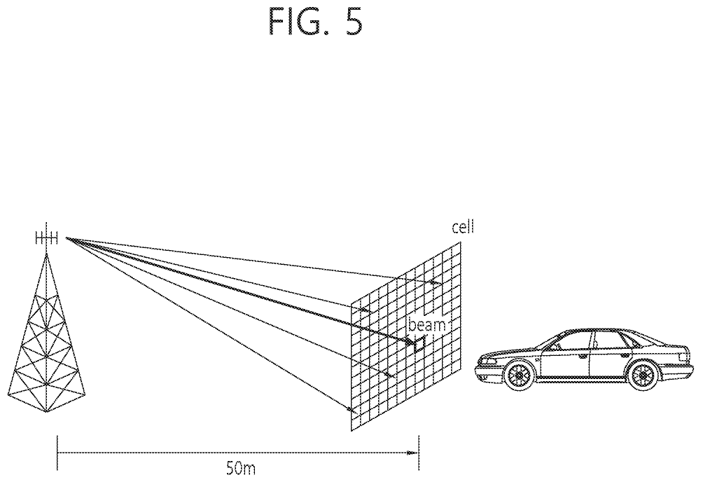

FIG. 5 shows an example of beam formation in a mobile OWC to which implementations of the present disclosure are applied.

Referring to FIG. 5, it is assumed that the distance between the transmitting and receiving ends is 50 meters, and the transmitting end is transmitting a pencil beam with a half angle of beam divergence of about 100 micro-radians. The expected beam diameter at the receiving end is between 5 mm and 3.5 cm.

Hereinafter, according to various implementations of the present disclosure, a method for configuring an optical beam to include inhomogeneous information and modulating it based on a two-dimensional beam pattern is described.

First, an inhomogeneous beam is described.

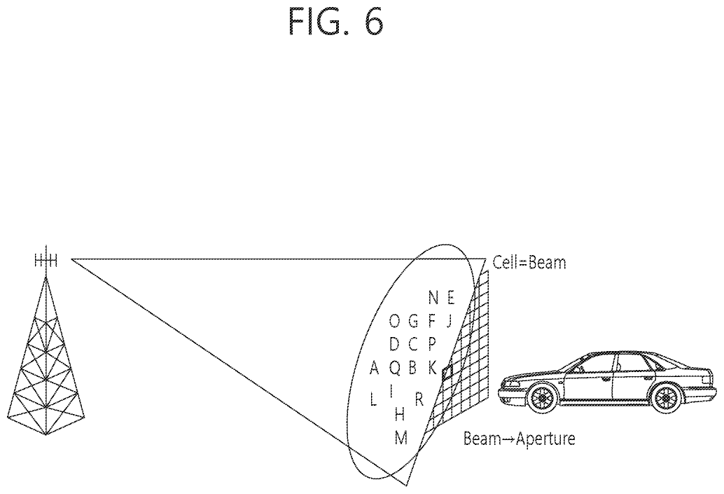

FIG. 6 shows an example of inhomogeneous beam formation to which implementations of the present disclosure are applied.

Referring to FIG. 6, the transmitting end transmits a wide inhomogeneous beam for beam search. The wide inhomogeneous beam may be transmitted over the entire cell area. The transmitted wide inhomogeneous beam may carry the letters ‘A’ through ‘R’, which represent different information (i.e., inhomogeneous information) depending on the location.

Depending on the position of the receive aperture at the receiving end, the information detected may be different. In FIG. 6, it is assumed that the position of the receive aperture is in the region of the beam where the information represented by ‘K’ is carried. The receiving end may detect the information (‘K’) through the receiving aperture.

An inhomogeneous beam may be defined as an optical beam that has inhomogeneous information about the wavefront perpendicular to the optical axis of the optical beam from the transmitting and receiving perspectives. In general, a beam consisting of inhomogeneous information may be called an inhomogeneous beam in an environment where the physical resources that distinguish beams in beam search are the same in time, frequency, and/or space. The inhomogeneous information transmitted over the inhomogeneous beam may include at least one of intensity, phase, and polarization.

When the inhomogeneous information is organized as intensity and/or phase, changes in intensity and/or phase may occur as a function of distance between the transmitting and receiving ends. Accordingly, it is not possible to distinguish between changes in intensity and/or phase due to position relative to the optical axis and changes due to distance. On the other hand, when inhomogeneous information is organized as polarization, the polarization does not vary with the distance between the transmitting and receiving ends. Therefore, inhomogeneous polarization may be used as inhomogeneous information that is independent of the distance and/or channel between the transmitting and receiving ends.

In the following description, it is assumed that the polarization with the lowest channel influence is used as the inhomogeneous information. However, this is only an example, and the inhomogeneous information may be configured in any form based on intensity, phase, and/or polarization. That is, the inhomogeneous information-based modulation described in the following description may be applied based on inhomogeneous information composed of intensity and/or phase as well as polarization.

A signal with arbitrary polarization may be represented as the sum of two arbitrary polarization signals for a single signal. For example, it may be represented that polarization 1+polarization 2=superposed polarization (for homogeneous symbols). Mathematically, this may be expressed as Equation 1.

$${A}_{m} {e}^{- j {θ}_{m}} \vert {P}_{m} 〉 + {A}_{n} {e}^{- j {θ}_{n}} \vert {P}_{n} 〉 = {A}_{c} {e}^{- j {θ}_{c}} \vert {P}_{c} 〉 \qquad [ Equation 1 ]$$

In Equation 1. Aₘ, Aₙ, and A_{c} denote the amplitudes of the m-th and n-th signals and the amplitude of the superposed signal, respectively. θₘ, θₙ, θ_{c} denote the phase of the m-th and n-th signals and the phase of the superimposed signal, respectively. |Pₘ>, |Pₙ>, |P_{c}>denote the polarization of the m-th and n-th signals and the polarization of the superimposed signal expressed as Jones Vectors, respectively.

Depending on the difference in amplitude and/or phase of each polarization, the characteristics of the superimposed polarization may vary. Equation 2 is an example of superimposed polarization.

$$\begin{matrix}{A}_{1} {e}^{- j {θ}_{1}} \vert H 〉 + {A}_{2} {e}^{- j {θ}_{2}} \vert V 〉 = \vert + 45 〉 , for {θ}_{1} = {θ}_{2} and {A}_{1} = {A}_{2} \\ {A}_{1} {e}^{- j {θ}_{1}} \vert H 〉 + {A}_{2} {e}^{- j {θ}_{2}} \vert V 〉 = \vert - 45 〉 , for {θ}_{1} + π = {θ}_{2} and {A}_{1} = {A}_{2} \\ {A}_{1} {e}^{- j {θ}_{1}} \vert H 〉 + {A}_{2} {e}^{- j {θ}_{2}} \vert V 〉 = \vert RCP 〉 , for {θ}_{1} + π / 2 = {θ}_{2} and {A}_{1} = {A}_{2} \\ {A}_{1} {e}^{- j {θ}_{1}} \vert H 〉 + {A}_{2} {e}^{- j {θ}_{2}} \vert V 〉 = \vert LCP 〉 , for {θ}_{1} - π / 2 = {θ}_{2} and {A}_{1} = {A}_{2} \\ {A}_{1} {e}^{- j {θ}_{1}} \vert RCP 〉 + {A}_{2} {e}^{- j {θ}_{2}} \vert LCP 〉 = \vert REP 〉 , for {θ}_{1} = {θ}_{2} and {A}_{1} > {A}_{2} \\ {A}_{1} {e}^{- j {θ}_{1}} \vert RCP 〉 + {A}_{2} {e}^{- j {θ}_{2}} \vert LCP 〉 = \vert LEP 〉 , for {θ}_{1} = {θ}_{2} and {A}_{1} < {A}_{2}\end{matrix} \qquad [ Equation 2 ]$$

In Equation 2, |H>, |V>, |45+>, and |−45>represent the horizontal polarization, vertical polarization, +45-degree polarization, and −45-degree polarization relative to the x-axis for linear polarization, respectively. |RCP>, |LCP>denote right circular polarization and left circular polarization, respectively. |REP|>, |LEP>denote right elliptical polarization and left elliptical polarization, respectively.

A beam that expresses all the different characteristics of superimposed polarizations according to difference in amplitude and/or phase of each polarization may be defined as a Poincare beam. Furthermore, the sphere that represents all cases of Poincare beams may be defined as a Poincare sphere.

Then, given two basis polarizations, RCP and LCP, a Poincare sphere may be plotted based on the amplitude and phase difference of each basis polarization. In addition, the Stokes parameters |S₀, S₁, S₂, S₃| may be defined to represent all polarization states on the Poincare sphere as shown in Equation 3.

$$\begin{matrix}{S}_{0} = {E}_{x}^{2} + {E}_{y}^{2} \\ {S}_{1} = {E}_{x}^{2} - {E}_{y}^{2} \\ {S}_{2} = 2 {E}_{x} {E}_{y} cos δ \\ {S}_{3} = 2 {E}_{x} {E}_{y} sin δ\end{matrix} \qquad [ Equation 3 ]$$

In Equation 3, Eₓ, E_{y} represent the E-field in the x-axis direction and the E-field in the y-axis direction, which generally correspond to horizontal and vertical polarization, respectively. δ represents the phase difference between Eₓ and E_{y}. Thus, S₀ represents the total intensity of the polarization state. S₁ represents the ratio difference between horizontal and vertical polarization, S₂ represents the ratio difference between +45 degree straight polarization and −45 degree straight polarization, and S₃ represents the ratio difference between RCP and LCP.

If the Stokes parameters described in Equation 3 are expressed in the spherical coordinate system of the Poincare sphere, they may be expressed as shown in Equation 4.

$$\begin{matrix}{S}_{0} = I \\ {S}_{1} = Ip cos 2 Ψ cos 2 X \\ {S}_{2} = Ip sin 2 Ψ cos 2 X \\ {S}_{3} = Ip sin 2 X\end{matrix} \qquad [ Equation 4 ]$$

In Equation 4, 1 represents the total intensity of the polarization state. p is the degree of polarization, which indicates the degree of polarization of the signal. p=0 indicates unpolarized. 0<p<1 indicates partially polarized, and p=1 indicates fully polarized. T is the orientation angle, which indicates the elliptical direction of the elliptical polarization. X is the ellipticity angle, which describes the degree of ellipticity of the elliptical polarization. Thus, T and X are independent of the total intensity 1 and the polarization angle p, and may be defined as the angle with respect to the S₁ axis on a Poincare sphere of fixed size 1. For the purposes of the present disclosure. ψ and X may be defined as Poincare sphere angles.

Extending the concept of superposition of polarizations to wavefronts for an arbitrary beam, the following example may be shown.

For example, if wavefront 1 is a plane wave horizontally polarized with θ1, and wavefront 2 is a plane wave vertically polarized with θ2, the superposed polarization results in RCP wavefront. θi+π/2=θᵢ₊₁ is assumed. that is, if each homogeneously polarized wavefront has homogeneous polarization, the superimposed wavefronts also have homogeneous polarization.

On the other hand, if the wavefronts have inhomogeneous phases, it may look like as follows. Here, inhomogeneous phase may be defined as unequal phases within the same wavefront, which may be, e.g., LG beams and/or HG beams.

For example, if wavefront 1 is a plane wave horizontally polarized with θ1 and wavefront 2 is a helical wave vertically polarized with θ1 to 04, the superimposed polarization results in an inhomogeneously polarized wavefront. θᵢ+π/2=θᵢ₊₁ is assumed. that is, if each homogeneous polarized wavefront has an inhomogeneous phase, there may be different phase differences at different locations within the superimposed wavefront, which may cause the superimposed polarization to change at different locations within the superimposed wavefront, resulting in inhomogeneous polarization.

For example, an LG beam is a Gaussian beam with an Orbital Angular Momentum (OAM) characteristic, where the phase is rotated within the wavefront according to a phase rotation characteristic parameter called the LG beam order or OAM order or topological charge. A plane wave or plane phasefront means that all electromagnetic waves have the same phase in a wavefront in which electromagnetic waves (or photons) propagate at the same time. Electromagnetic waves that are not plane waves are called helical waves, and in general, helical waves are electromagnetic waves with an OAM. Since OAM is a definition of the wavefront, the electromagnetic wave at each point may be linearly polarized or circularly polarized. By optical definition, OAMs may be referred to as LG beams or cylindrical transverse mode patterns. The cylindrical transverse mode pattern may be represented by TEM(pl)). In the present disclosure, TEM(pl) is defined as TEM(pl) where p=0 and 1 is a value corresponding to the LG beam order. For example, LG beam order 3 or OAM mode 3 may be represented by TEM(03). The LG beam order is an integer value such that the direction of rotation of the phase within the wavefront when it is negative is opposite to the direction when it is positive.

Two or more homogeneously polarized wavefronts may be superimposed to generate an inhomogeneously polarized wavefront. Depending on the number and configuration of the superimposed homogeneously polarized wavefronts, the distribution of polarization states of the superimposed beam may be different. Furthermore, the optical axes or centers of the beams may be aligned identically or may be arbitrarily skewed, and the distribution of polarization states of the superimposed beams may vary accordingly. Furthermore, the fundamental polarizations of the homogeneously polarized wavefronts may be orthogonal or non-orthogonal to each other, and the distribution of polarization states of the superimposed beams may be different depending on the fundamental polarization used. Furthermore, the distribution of polarization states of the superimposed beams may vary depending on the initial phase value of each wavefront. Furthermore, the distribution of polarization states of the superimposed beams may be different depending on the initial amplitude value of each wavefront. Furthermore, the distribution of polarization states of the superimposed beams may be different depending on the distribution of inhomogeneous phases of each wavefront.

The inhomogeneous polarization may be generated on a wavefront-by-wavefront basis. In the present disclosure, inhomogeneous polarization generated on a wavefront-by-wavefront basis is defined as an inhomogeneous polarization pattern.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

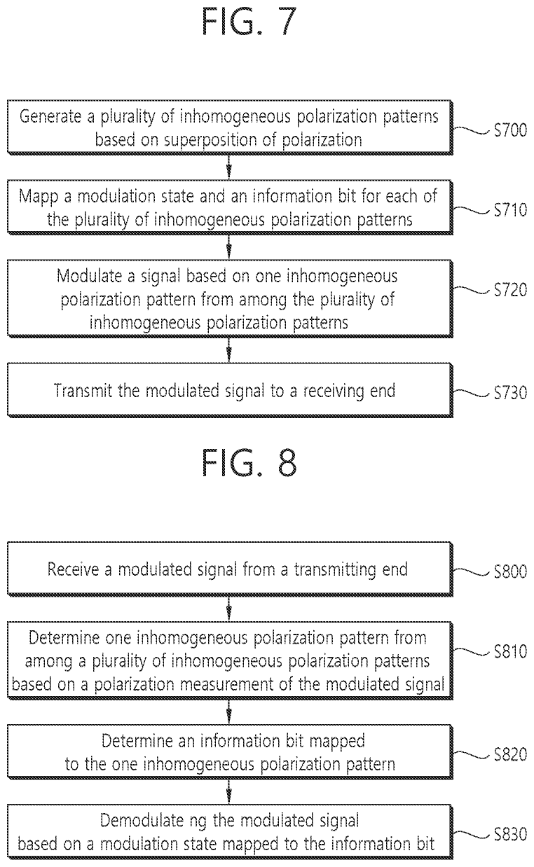

FIG. 7 shows a method performed by a transmitting end to which implementations of the present disclosure are applied.

In step S700, the method comprises generating a plurality of inhomogeneous polarization patterns based on superposition of polarization.

In step S710, the method comprises mapping a modulation state and an information bit for each of the plurality of inhomogeneous polarization patterns

In step S720, the method comprises modulating a signal based on one inhomogeneous polarization pattern from among the plurality of inhomogeneous polarization patterns.

In step S730, the method comprises transmitting the modulated signal to a receiving end.

In some implementations, each of the plurality of inhomogeneous polarization patterns may be generated based on a type of basis for the superposition of polarization, an amplitude of the basis, an initial phase of the basis, and an LG beam order of the basis. Each of the plurality of inhomogeneous polarization patterns may be generated by an inhomogeneous polarization modulator of the transmitting end, and the type of the basis for the superposition of polarization, the amplitude of the basis, the initial phase of the basis, and the LG beam order of the basis are provided to the inhomogeneous polarization modulator of the transmitting end by an IP pattern controller of the transmitting end.

In some implementations, a number of the plurality of inhomogeneous polarization patterns may be N, and a length of the information bit may be B=log 2N.

In some implementations, each of the plurality of inhomogeneous polarization patterns may be expressed by an inhomogeneous polarization pattern matrix.

In some implementations, the inhomogeneous polarization pattern matrix may be determined by minimizing a similarity between patterns.

In some implementations, the plurality of inhomogeneous polarization patterns may be generated based on a difference from a homogeneous polarization pattern.

In some implementations, mapping of the modulation state and the information bit for each of the plurality of inhomogeneous polarization patterns may be performed by an IP pattern controller of the transmitting end.

In some implementations, information related to mapping of the modulation state and the information bit for each of the plurality of inhomogeneous polarization patterns may be pre-configured between the transmitting and the receiving end. The information related to the mapping may be expressed by a mapping table.

In some implementations, the modulated signal may be transmitted by being mixed with an analog signal modulated by a conventional modulation method.

FIG. 8 shows a method performed by a receiving end to which implementations of the present disclosure are applied.

In step S800, the method comprises receiving a modulated signal from a transmitting end.

In step S810, the method comprises determining one inhomogeneous polarization pattern from among a plurality of inhomogeneous polarization patterns based on a polarization measurement of the modulated signal.

In step S820, the method comprises determining an information bit mapped to the one inhomogeneous polarization pattern.

In step S830, the method comprises demodulating the modulated signal based on a modulation state mapped to the information bit.

In some implementations, determining of the one inhomogeneous polarization pattern may be performed by a polarization state detector of the receiving end.

For example, the polarization state detector may comprise at least one polarization filter and at least one photo detector array, and the polarization measurement may be performed based on a power output by an intensity-modulated signal passing through the at least one polarization filter and the at least one photo detector array.

For example, the polarization state detector may comprise at least one polarization filter and at least one coherent detector array, and the polarization measurement may be performed based on a power output by an in-phase and quadrature-modulated complex signal passing through the at least one polarization filter and the at least one coherent detector array. The at least one coherent detector array may comprise a 3 dB coupler and a balanced optical detector.

In some implementations, the one inhomogeneous polarization pattern may be determined based on a Euclidean distance between each spatial index of an inhomogeneous polarization pattern and a Stokes parameter obtained based on the polarization measurement.

In some implementations, the plurality of inhomogeneous polarization patterns may be based on a difference from a homogeneous polarization pattern.

In some implementations, the demodulated signal may be combined with a digital signal demodulated by a conventional demodulation method and finally decoded.

Hereinafter, various implementations of the present disclosure will be described.

### 1. First Implementation: Inhomogeneous Polarization Pattern Based Modulation Design

According to the first implementation of the present disclosure, a signal may be modulated and demodulated based on an inhomogeneous polarization pattern. As described above, an inhomogeneous polarization wavefront may be generated based on the superposition of polarization. If the polarization superposition scheme is configured based on a previously agreed rule, it is possible to generate a predetermined inhomogeneous polarization pattern. Therefore, in the first implementation of the present disclosure, a method is provided for generating an inhomogeneous polarization pattern by superimposing polarization based on a previously agreed rule, and using the generated inhomogeneous polarization pattern as a modulation state. Hereinafter, for convenience of explanation, the inhomogeneous polarization pattern is referred to as an Inhomogeneous Polarization (IP) pattern.

In the first implementation of the present disclosure, one IP pattern may be defined/mapped to one modulation state, and an IP pattern set corresponding to a set of modulation states may be defined as S. The size of the IP pattern set |S|=N, then IP Pattern based Modulation (IPM) may be referred to as N-IPM.

If the set of IP pattern matrices S={Pi}(i=1, . . . , N), then the i-th IP pattern matrix Pᵢ may be expressed by Equation 5.

$$[ \begin{matrix}{p}_{1 , 1} & {p}_{1 , 2} & … & {p}_{1 , M - 1} & {p}_{1 , M} \\ {p}_{2 , 1} & {p}_{2 , 2} & … & {p}_{2 , M - 1} & {p}_{2 , M} \\ … & … & {p}_{i , j} & … & … \\ {p}_{M - 1 , 1} & {p}_{M - 1 , 2} & … & {p}_{M - 1 , M - 1} & {p}_{M - 1 , M} \\ {p}_{M , 1} & {p}_{M , 2} & … & {p}_{M - 1 , M} & {p}_{M , M}\end{matrix} ] \qquad [ Equation 5 ]$$

In Equation 5, M represents the degree of quantization for the elements of the IP pattern in space.

In Equation 5, p_{i,j} is the (i,j)-th spatial polarization value of the IP pattern matrix. For example, the polarization value may be a Stokes vector composed of Stokes parameters.

The IP pattern matrix may be generated through polarization superposition. The IP pattern matrix may be determined by the type of basis for polarization superposition and the amplitude, initial phase, and/or LG Beam order of each basis, etc. For example, Equation 6 shows an example of an IP pattern matrix.

$$\begin{matrix}{P}_{i} = {f}_{IP} ( {B}_{1} , … , {B}_{L} , & {A}_{1} , … , {A}_{L} , & {θ}_{1} , … , {θ}_{L} , & {LG}_{1} , … , {LG}_{L} )\end{matrix} \qquad [ Equation 6 ]$$

In Equation 6, f_{IP}(parameters) represents a function that generates an IP wavefront by superimposing L polarization basis. L is the number of basis for polarization superposition. Parameter is a control parameter for each polarization basis.

In Equation 6, Bⱼ represents the j-th polarization basis for IP pattern generation. For example, Bⱼ ∈{|H>,|V>, |45+>, −45>,|RCP>,|LCP>}.

In Equation 6, A, represents an amplitude for the j-th polarization basis for IP pattern generation. For example, Aⱼ ∈[0, 1].

In Equation 6, θⱼ represents a phase for the j-th polarization basis for IP pattern generation. For example, θⱼ ∈ [−π, π].

In Equation 6, LGⱼ represents an LG beam order for the j-th polarization basis for IP pattern generation. For example, LGⱼ may be an integer value.

Since one IP pattern is defined/mapped to one modulation state, the number of modulation states is N=|S|, and the length of the corresponding bit mapping sequence is B=log₂(N).

In summary, N modulation states may correspond to IP patterns generated by pre-configured rules. The number of modulation states, N, may be defined as N=2^{B} by the number of bits B in terms of modulation. The IP pattern matrix Pᵢ may correspond to the modulation state, and thus may correspond to the information bit stream.

For example, w % ben N=4 (i.e., B=2) in N-IPM, the IP pattern corresponding to the modulation state may be exemplified as follows.
Set of IP pattern matrices: S={Pᵢ}(i=1, 2, 3, 4)
Number of modulation states: N=4
Length of bit mapping sequence: B=2

$$\begin{matrix}{P}_{1} = {f}_{IP} ( \vert RCP > , \vert H > , \vert LCP > , \vert V > , 1 , 0 , 1 , 0 , π / 4 , π / 2 , 0 , 0 , - 1 , 0 , 0 , 0 ) \\ {P}_{2} = {f}_{IP} ( \vert RCP > , \vert H > , \vert LCP > , \vert V > , 1 , 1 , 1 , 1 , π / 4 , π / 2 , 3 π / 4 , - π / 4 , - 1 , - 2 , 0 , 2 ) \\ {P}_{3} = {f}_{IP} ( \vert RCP > , \vert H > , \vert LCP > , \vert V > , 1 , 1 , 1 , 1 , π / 4 , π / 7 , 3 π / 5 , - π / 3 , - 1 , - 3 , 2 , 4 ) \\ {P}_{4} = {f}_{IP} ( \vert RCP > , \vert H > , \vert LCP > , \vert V > , 1 , 0 , 1 , 0 , 0 , 0 , 0 , 0 , 1 , 0 , 0 , 0 )\end{matrix}$$

For example, the first IP pattern matrix P₁ is generated by superimposing four polarization bases with L=4. At this time, B₁=|RCP>, B₂=H>, B₃=|LCP>, B₄=|V>, A₁=1, A₂=0, A₃=1, A₄=0, θ₁=π/4, θ₂=π/2, θ₃=0, θ₄=0. LG₁=−1, LG₂=0, LG₃=0, LG₄=0.

According to the example above, the mapping relationship between the IP pattern matrix and the modulation state for 4-IPM may be expressed as Table 3 below.

TABLE 3

| Modu- | | | |
|---|---|---|---|
| lation | | | |
| State | Bit | IP | |
| Index i | Mapping | Pattern | IP Generation Information |
| 1 | 00 | P₁ | f_{IP} (\|RCP>, \|H>, \|LCP>, \|V>, 1, 0, |
| | | | 1, 0, π/4, π/2, 0, 0, −1, 0, 0, 0) |
| 2 | 01 | P₂ | f_{IP} (\|RCP>, \|H>, \|LCP>, \|V>, 1, 1, |
| | | | 1, 1, π/4, π/2, 3π/4, −π/4, −1, −2, 0, 2) |
| 3 | 10 | P₃ | f_{IP} (\|RCP>, \|H>, \|LCP>, \|V>, 1, 1, |
| | | | 1, 1, π/4, π/7, 3π/5, −π/3, −1, −3, 2, 4) |
| 4 | 11 | P₄ | f_{IP} (\|RCP>, \|H>, \|LCP>, \|V>, 1, 0, |
| | | | 1, 0, 0, 0, 0, 0, 1, 0, 0, 0) |

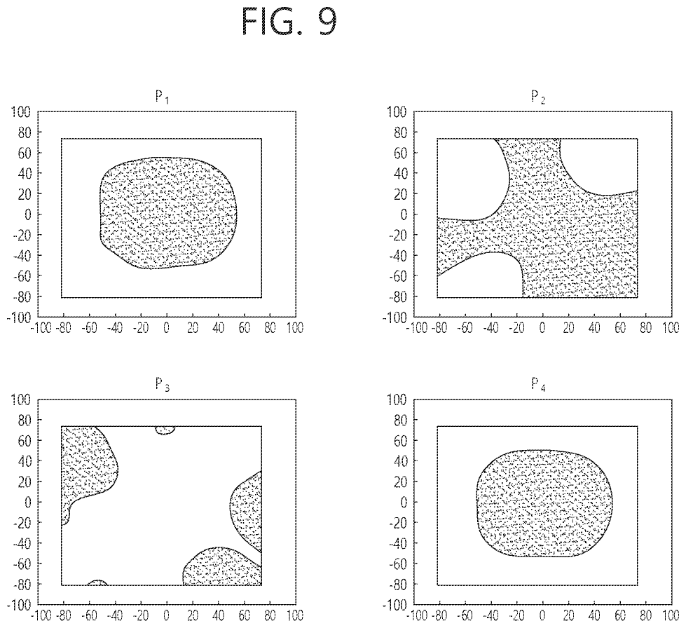

FIG. 9 is an example of each IP pattern matrix for 4-IPM to which the first implementation of the present disclosure is applied.

Referring to FIG. 9, it is assumed that M=21, which is the degree to which the IP pattern matrix is quantized in space. In FIG. 9, the shaded portion represents a polarization state in which the LCP component is dominant, and the unshaded portion represents a polarization state in which the RCP component is dominant. The elements p_{i,j} of each IP pattern matrix may be expressed as Stokes parameters according to the polarization state.

For example, the elements p_{i,j}⁽¹⁾ of the IP pattern matrix P₁ may be expressed by Equation 7.

$${p}_{i , j}^{( 1 )} = {A}_{1} {e}^{- j {θ}_{1}} {B}_{1} {LG}_{1} ( i , j ) + {A}_{2} {e}^{- j {θ}_{2}} {B}_{2} {LG}_{2} ( i , j ) + {A}_{3} {e}^{- j {θ}_{3}} {B}_{3} {LG}_{3} ( i , j ) + {A}_{4} {e}^{- j {θ}_{4}} {B}_{4} {LG}_{4} ( i , j ) \qquad [ Equation 7 ]$$

In Equation 7, LGₒ(i,j) is beam information for the (i,j)-th space when the LG beam order is o, and the amplitude and phase of the beam may be determined according to the spatial location (i,j).

Here, since each parameter is a parameter that constitutes the IP pattern matrix P₁, if each parameter value for P₁ explained as an example above is substituted, the element p_{i,j}⁽¹⁾ of the IP pattern matrix P₁ may be expressed as Equation 8.

$${p}_{i , j}^{( 1 )} = {e}^{- j \frac{π}{4}} \vert RCP 〉 {LG}_{- 1} ( i , j ) + \vert LCP 〉 {LG}_{0} ( i , j ) \qquad [ Equation 8 ]$$

In the same way, the polarization values on all (i,j)-th spaces may be derived.

In the same way, the transmitting end may set the IP pattern matrix for all N according to the predefined rule, and define the N-IPM mapping table in advance. The N-IPM mapping table may be agreed upon between the transmitting and the receiving end. In addition, the N value for modulation may be configured, and the configured N value may be known from the transmitting to the receiving end or from the receiving end to the transmitting end.

The transmitting end may map the information bits to the IP pattern matrix based on the configured N value, and transmit the beam generated based on the corresponding IP pattern matrix to the receiving end.

The receiving end may measure the IP polarization beam through polarization measurement, and de-map the IP pattern matrix based on the configured N value to decode the information bits.

In the above, the method of determining the IP pattern matrix may be derived as a method of minimizing the similarity between patterns. For example, the IP pattern matrix may be determined according to Equation 9.

$$arg {max}_{{P}_{i} , {P}_{j}} {‖ {P}_{i} - {P}_{j} ‖}_{F} = \sqrt{{\sum }_{n , m = 1}^{M} {\vert {p}_{n , m}^{( i )} - {p}_{n , m}^{( j )} \vert}^{2}} , i \neq j and i , j = 1 , … , N \qquad [ Equation 9 ]$$

However. Equation 9 is only an example, and the IP pattern matrix may be determined from an implementation perspective, or may be determined in a way that the IP pattern matrix is pre-configured.

In addition, the method of determining the IP pattern matrix may be configured differently depending on the number of modulation states, N.

### 2. Second Implementation: Inhomogeneous Polarization Pattern Based Modulator/Demodulator Design

According to the second implementation of the present disclosure, a transmitter and a receiver used in the N-IPM system described in the first implementation of the present disclosure may be configured/designed. That is, the operations of the transmitting end and the receiving end according to the first implementation of the present disclosure described above may be performed by the transmitter and the receiver according to the second implementation of the present disclosure described below, respectively.

### (1) Transmitter Structure

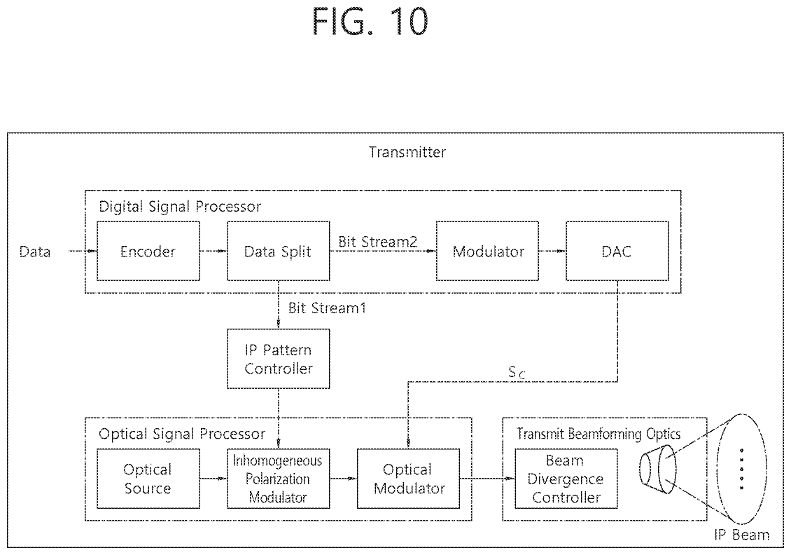

FIG. 10 shows an example of a structure of a transmitter to which the second implementation of the present disclosure is applied.

Referring to FIG. 10, the transmitter is composed of a digital signal processor for processing digital data, an IP pattern controller for controlling an IP pattern, an optical signal processor for generating an optical source based on an IP pattern, and a transmit beamforming optics for beamforming a signal based on the generated IP pattern.

### a) Digital Signal Processor

The digital signal processor consists of an encoder for encoding data to be transmitted, a data split for branching data, a modulator for modulating the encoded data, and a Digital-to-Analog Convertor (DAC) for converting the modulated digital signal into an analog signal. The converted analog signal is applied to an optical modulator of an optical signal processor

The encoder encodes data to be transmitted (i.e., information bit stream).

The data split branches the data into bit stream 1 modulated through N-IPM and bit stream 2 modulated through a conventional modulation scheme (e.g., Phase Shift Keying (PSK), Quadrature Amplitude Modulation (QAM), etc.), and applies the branched data to each modulator. Accordingly, the signal may be modulated using a modulation scheme agreed upon between the transmitter and the receiver.

In FIG. 10, the case where data is branched into bit stream 1 modulated through N-IPM and bit stream 2 modulated through a conventional modulation scheme is described, but this is only an example, and it is also possible for all data to be modulated only through N-IPM without combining a separate conventional scheme method.

The bit stream 1 modulated through N-IPM is applied to the IP pattern controller described below.

The bit stream 2 modulated through the conventional modulation scheme is modulated through a pre-agreed modulation scheme and applied to the optical modulator through the DAC.

### b) IP Pattern Controller

The IP pattern controller determines the modulation state according to the N-IPM mapping table described in the first implementation of the present disclosure. In addition, a control signal is transmitted to the inhomogeneous polarization modulator, in order to generate an IP pattern corresponding to the corresponding modulation state by the inhomogeneous polarization modulator in the optical signal processor. The control signal is L polarization basis Bⱼ, amplitude Aⱼ of each polarization basis, initial phase θⱼ, of each polarization basis, and LG beam order LGⱼ of each polarization basis for generating the IP pattern.

### c) Optical Signal Processor

The optical signal processor generates an initial optical beam from an optical source, and operates an inhomogeneous polarization modulator based on control information transmitted from an IP pattern controller to generate a beam to which an IP pattern is applied. The beam to which the IP pattern is applied is multiplied by a signal modulated by a conventional modulation scheme in the optical modulator, and is applied to transmit beamforming optics. Then, the IP beam is transmitted toward a receiver through a beam divergence controller.

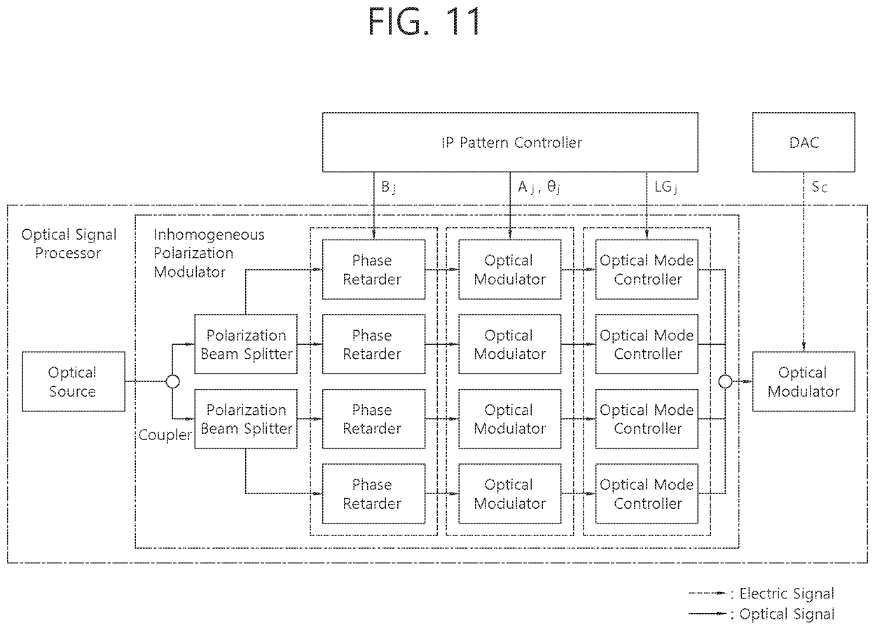

FIG. 11 shows an example of a detailed structure of an inhomogeneous polarization modulator in an optical signal processor to which the second implementation of the present disclosure is applied.

FIG. 11 shows an example of a case where L=4, i.e., four polarization bases for generating an IP beam, are superimposed. The detailed operation of the inhomogeneous polarization modulator is as follows.
The initial beam generated from the optical source is split through a coupler or a polarization beam splitter.
A polarization beam splitter is an optical device that splits horizontal polarization and vertical polarization, and splits the horizontal polarization H> and vertical polarization |V>components of the initial beam input from the coupler.
A phase retarder is a device that converts the polarization of the incident beam, and may be composed of a half-wave plate or a quarter-wave plate. Each horizontal polarization and vertical polarization split from the polarization beam splitter is converted into a target polarization by the phase retarder. At this time, the target polarization is a polarization basis Bⱼ input from the IP pattern controller.
An optical modulator is a device that controls the amplitude and initial phase for each polarization basis Bⱼ generated through the phase retarder. An optical amplifier in the optical modulator may control the optical amplitude of each split beam. The controlled amplitude is the amplitude A; for each polarization basis input from the IP pattern controller. The phase controller in the optical modulator may control the initial phase of each split beam. The controlled initial phase is the initial phase θⱼ for each polarization basis input from the IP pattern controller.
The optical mode controller is a device that controls the LG beam order for each polarization basis and may be composed of a spatial light modulator, a spiral phase plate, a phase shift hologram, a metasurface, etc. The spatial light modulator, spiral phase plate, phase shift hologram, metasurface, etc., may control the LG beam order or HG beam order, which is the mode of each branched beam.
The coupler is an optical device that re-superimposes each branched and converted beam.
The IP beam generated through polarization superposition is mixed with the analog signal Sc output from the DAC and transmitted by the optical modulator.

An example of the operation of the inhomogeneous polarization modulator based on the polarization superposition is as follows.
The unpolarized beam (or linear polarized beam) generated from the optical source is split 1:1 at the coupler.
Since the split initial beam has the same ratio of horizontal polarization and vertical polarization, it is split into each path with the same ratio of horizontal polarization and vertical polarization at the polarization beam splitter.
If the phase retarder of the vertical polarization path is a Quadrant quarter Waveplate (QWP), the vertical polarization is converted to RCP, and if the phase retarder of the horizontal polarization path is a QWP, the horizontal polarization is converted to LCP.
The amplitude Aⱼ and the phase θⱼ are applied to each polarization basis path.
If the RCP path is the basis index 1 and the LG beam order m for it, the output beam is A₁exp{−iθ₁)}RCP>LGₘ. In the same way, if the LCP path is a basis index 2 and the LG beam order for it is n, the output beam is A₂exp{−iθ₂}|LCP>LGₙ. In this way, if beams are generated and output for each of the four basis paths, they are superimposed at the coupler to form a superimposed beam, which soon becomes an IP beam. For example, the final IP beam may be expressed by Equation 10.

$$IP Beam = {A}_{1} exp \{ - i {θ}_{1} \} \vert RCP 〉 {LG}_{m} + {A}_{2} exp \{ - i {θ}_{2} \} \vert LCP 〉 {LG}_{n} + {A}_{3} exp \{ - i {θ}_{3} \} \vert H 〉 {LG}_{o} + {A}_{4} exp \{ - i {θ}_{4} \} \vert V 〉 {LG}_{p} \qquad [ Equation 10 ]$$

The IP beam generated in this way is mixed with the analog signal S_{c} modulated by the conventional modulation scheme and transmitted (i.e., output beam=S_{c}*IP beam).

In the description of FIG. 11, some elements may be replaced with a single element that performs two or more identical functions.

In FIG. 11, for the convenience of explanation, the case where four beams are superimposed is described, but this is only an example. The inhomogeneous polarization modulator according to the second implementation of the present disclosure described in FIG. 11 may also be applied to cases where more than four or fewer than four beams are superimposed. In this case, the method described in FIG. 11 may be repeated to additionally superimpose multiple beams, or some beams may be removed.

Returning to FIG. 10, the optical modulator performs optical modulation based on the amplitude and phase values received from the IP pattern controller, or based on the analog signal received from the digital signal processor. Optical modulation may be configured differently depending on the transmission/reception scheme. Intensity Modulation/Direct Detection (IM/DD) and coherent transmission and detection.

In the IM/DD scheme, optical modulators may use Mach-Zehnder Modulator (MZM) and Electro-Absorption Modulator (EAM), etc. MZM is a device that configures two phase modulators in parallel, splits the incident optical signal into two, and combines the outputs after the operation of the phase modulators of each path. At this time, the operation of each phase modulator is operated by an analog signal applied from the digital signal processor. MZM is an intensity modulator that utilizes the phenomenon that when the phases of the two phase modulators are the same, the intensity is maintained by constructive interference and only the phase changes, and when the phase difference is n, the intensity disappears by destructive interference. EAM is a semiconductor device that controls the intensity of an optical signal based on voltage. It operates by the Franz-Keldysh effect, in which the degree of absorption of photons in a semiconductor changes when an electric field is applied. EAM has the characteristic of being easy to integrate as a semiconductor device, but since the output optical power is about 3 dBm, an optical amplifier is required.

The optical modulator determines the phase shift value based on the wavelength, electrode length, and effective refractive index. The effective refractive index has a linear relationship with the external control voltage u(t), and the effective refractive index changes according to the change in the external voltage, and the phase also changes accordingly. When the external control voltage that creates a phase shift of π is V_{π}, the transfer function of the optical modulator may be expressed by Equation 11.

$${E}_{out} ( t ) = {E}_{in} ( t ) \cdot {e}^{j \frac{μ ( t )}{{V}_{π}} π} \qquad [ Equation 11 ]$$

Similarly, the transfer function of an MZM consisting of two phase modulators may be expressed by Equation 12.

$${E}_{out} ( t ) = {E}_{in} ( t ) \cdot \frac{1}{2} \cdot ( {e}^{j \frac{μ 1 ( t )}{{V}_{π 1}} π} + {e}^{j \frac{μ2 ( t )}{{V}_{π 2}} π} ) \qquad [ Equation 12 ]$$

In the case of coherent transmission and detection scheme, the optical modulator may use an In-phase/Quadrature (IQ) modulator. The IQ modulator may be configured by configuring two MZM modules in parallel and inserting a phase shifter corresponding to π/2 into one path. Each path is used to modulate an in-phase signal and a quadrature signal, respectively, so that both intensity and phase may be modulated.

The optical IQ modulator performs in-phase modulation by a control voltage u(t) by an in-phase signal, performs quadrature modulation by a control voltage u_{Q}(t) by a quadrature signal, and then synthesizes them to generate an IQ-modulated signal. The transfer function of the optical IQ modulation may be expressed by Equation 13.

$${E}_{out} ( t ) = {E}_{in} ( t ) \cdot \frac{1}{2} \cdot ( cos ( \frac{{u}_{I} ( t )}{{V}_{π}} \frac{π}{2} ) + j cos ( \frac{{u}_{Q} ( t )}{{V}_{π}} \frac{π}{2} ) ) \qquad [ Equation 13 ]$$

### d) Transmit Beamforming Optics

Returning to FIG. 10, the transmit beamforming optics performs transmit beamforming of an optic-modulated signal received from an optical signal processor, such as an array antenna, a collimator, a lens, or a metasurface, towards a receiver. Depending on its configuration, the transmit beamforming optics may be composed of a single element (e.g., an array antenna or a lens) or may be composed of various combinations of multiple elements (e.g., a single antenna+a lens, a lens+a metasurface, etc.).

The transmit beamforming optics may include a beam divergence controller. The beam divergence controller may control the intended beam divergence. That is, the above-described IP beam may be expanded to the intended beam size and transmitted through the beam divergence controller. For example, the beam divergence controller may control the beam divergence based on the distance between the transmitter and the receiver so that the receiver can receive the IP beam.

### (2) Receiver Structure

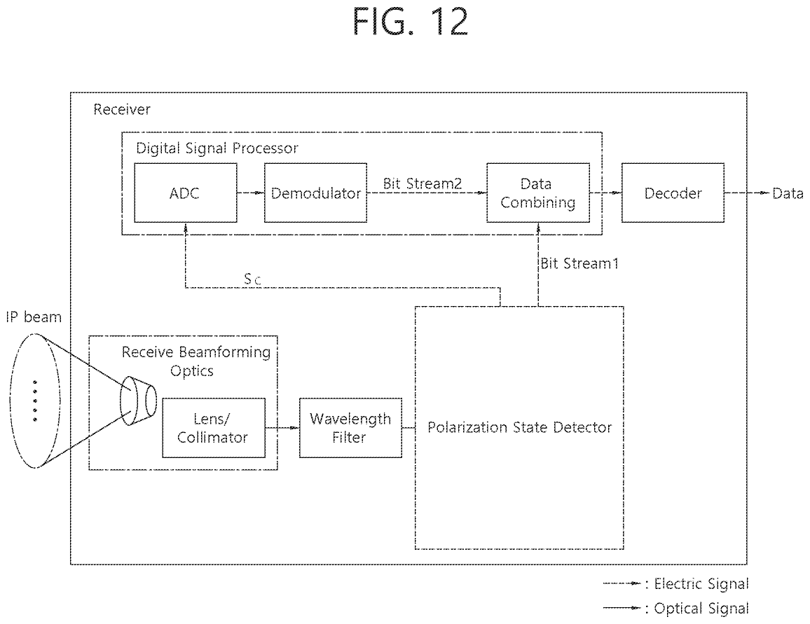

FIG. 12 shows an example of a structure of a receiver to which the second implementation of the present disclosure is applied.

Referring to FIG. 12, the receiver is composed of receive beamforming optics that receives through a receiver aperture, a polarization state detector for IP pattern detection, and a digital signal processor for electrical demodulation.

### a) Receive Beamforming Optics

The receive beamforming optics performs receive beamforming of a target signal received through the receiver aperture, such as an array antenna, a collimator, a lens, and a metasurface, etc. Depending on its configuration, the receive beamforming optics may be composed of a single element (e.g., an array antenna or a lens, etc.) or may be composed of various combinations of multiple elements (e.g., a single antenna+lens, a lens+metasurface, etc.). The receive beamforming optics collects and applies an optical signal incident through a lens to an optical fiber. The applied beam is transmitted to a wavelength filter.

### b) Wavelength Filter (or Optical Filter)

The wavelength filter is an optical filter device that passes only a desired signal among received signals, and functions as a bandpass filter.

### c) Polarization State Detector

The polarization state detector obtains polarization state information through a polarization filter and a photo detector array. The configuration of a polarization state detector may vary depending on the configuration and type of the polarization filter and the photo detector array. The intensity of a signal passing through each polarization filter is measured in a photo detector array. The photo detector array is an optical converter composed of a plurality of photodiodes that converts the intensity of an optical signal into photocurrent. The photo detector array may be composed of an array including M² photo detectors for recognizing an IP pattern, and may be implemented to be larger or smaller than M² depending on the implementation. The photocurrent is converted into voltage through a low-pass filter and a Transimpedance Amplifier (TIA).

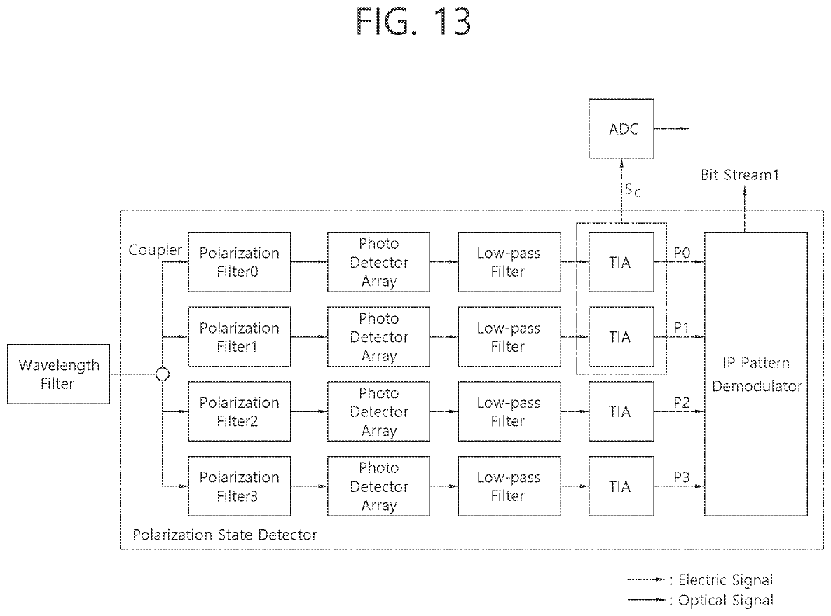

FIG. 13 shows an example of a detailed structure of a polarization state detector to which the second implementation of the present disclosure is applied.

FIG. 13 shows a detailed structure of a polarization state detector that receives an applied signal and an IP pattern from a conventional modulator modulated by intensity. In FIG. 13, the polarization state detector may measure the Stokes parameter. A desired signal that has passed through a wavelength filter is split into four signals in a coupler. In FIG. 13, it is assumed that the ratio of the four split signals is the same, but the ratio may vary depending on the purpose. Each split path may pass a signal through a different polarization filter. For example, polarization filter 0 may be a horizontal polarizer, polarization filter 1 may be a vertical polarizer, polarization filter 2 may be a +45 degree linear polarizer, and polarization filter 3 may be composed of a serial connection of a QWP and a +45 degree polarizer.

The power measured by the optical detector of each path is a total of four from P₀ to P₃, and among them, P₀ and P₁ are combined and applied to the ADC of the digital signal processor. Depending on the characteristics of each polarizer passed through, P₀ to P₃ may be expressed by Equation 14.

$${P}_{0} = {\vert {E}_{x} \vert}^{2} \\ {P}_{1} = {\vert {E}_{y} \vert}^{2} \\ {P}_{2} = \frac{1}{2} ( {E}_{x}^{2} + {E}_{y}^{2} + 2 {E}_{x} {E}_{y} cos δ ) \\ {P}_{3} = \frac{1}{2} ( {E}_{x}^{2} + {E}_{y}^{2} + 2 {E}_{x} {E}_{y} sin δ ) \qquad [ Equation 14 ]$$

Therefore, the Stokes parameter may be obtained as in Equation 15 through the output power of Equation 14.

$${S}_{0} = {P}_{0} + {P}_{1} \\ {S}_{1} = {P}_{0} - {P}_{1} \\ {S}_{2} = 2 {P}_{2} - {P}_{0} - {P}_{1} \\ {S}_{3} = 2 {P}_{3} - {P}_{0} - {P}_{1} \qquad [ Equation 15 ]$$

The polarization state may be obtained through the above-obtained Stokes parameters.

Since the component for the intensity signal transmitted by the IP beam is common to the x-axis component and y-axis component constituting the polarization, it may be expressed as |sᵢ|²=EₛE₈*. Here, Eₛ is the received signal converted into an amplitude signal through the PD and TIA, and Eₛ* is the complex conjugate of Eₛ. Since the signal is equally divided in the coupler, Eₓ and E_{y} for reconstructing Eₛ become ½ in terms of power, and may be expressed as |S_{c}|²=2|Eₓ|²+2|E_{y}|². Therefore, the power of the intensity signal |S_{c}|=2(P₀+P₁) may be obtained through the above-mentioned output power.

In the above, P₀ to P₃ may be obtained individually for each photodetector of the photodetector array. In this case, the output power may be obtained as many as the number of photodetectors constituting the photodetector array. For example, for a photodetector array including M² photodetectors, the output power measured individually for the photodetectors may be expressed as P₀(i,j), P₁(i,j), P₂(i,j), P₃(i,j) (i,j=1, . . . , M). Accordingly, the Stokes parameter may be measured for each photodetector index (i,j).

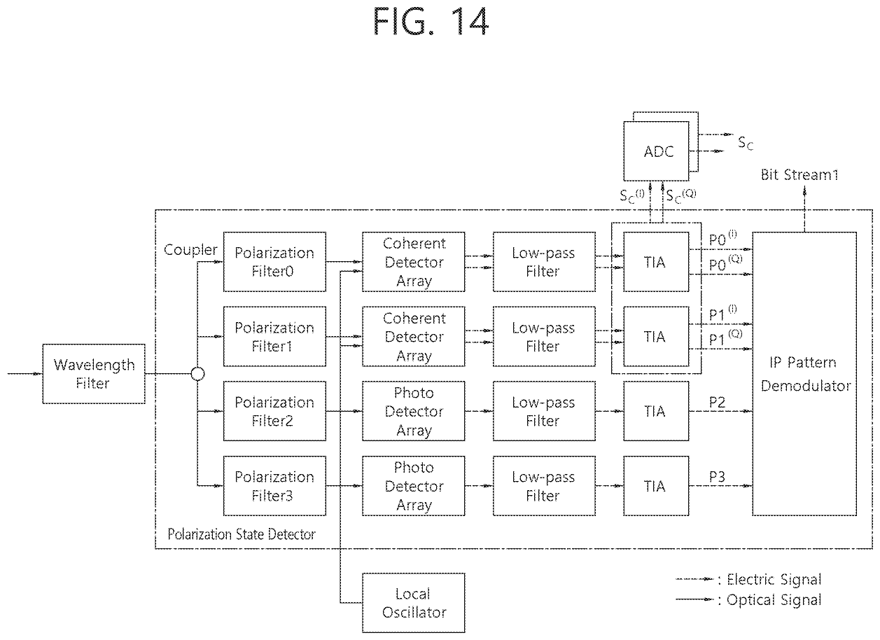

FIG. 14 shows another example of a detailed structure of a polarization state detector to which the second implementation of the present disclosure is applied.

FIG. 14 shows a detailed structure of a polarization state detector that receives a complex signal (i.e., a signal modulated in-phase/quadrature) and an IP pattern.

Referring to FIG. 14, the coherent detector array and the local oscillator may be configured through a 90-degree hybrid and a balanced PD.

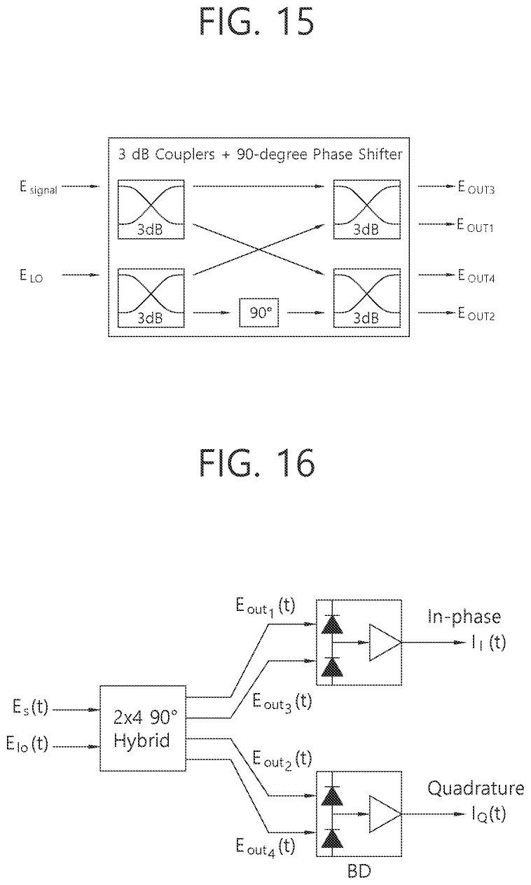

FIG. 15 shows an example of a coherent detector to which the second implementation of the present disclosure is applied.

Referring to FIG. 15, one coherent detector constituting the coherent detector array has two outputs each by two balanced PDs. Accordingly, each path in which a low-pass filter and a TIA are configured is also configured with two, but in FIG. 15, it is schematically expressed only as a line for convenience of explanation.

IQ modulation for coherent detection is implemented as a 90-degree hybrid, and mixes the modulated carrier received through a 3-dB coupler and a 90-degree phase shifter with the output of the local oscillator. In the 90-degree hybrid, the received signal may be expressed by Equation 16.

$${E}_{s} ( t ) = \sqrt{{P}_{s}} {e}^{j ( {ω}_{s} t + {φ}_{s} )} \cdot a ( t ) \cdot {e}^{j φ ( t )} \cdot {e}^{j {φ}_{{n}_{s}} ( t )} \qquad [ Equation 16 ]$$

In Equation 16, Pₛ, wₛ, φₛ are the power, frequency, and phase of the received signal, a(t), φ(t) are the amplitude and phase of the phase-modulated signal (e.g., QAM signal), and φₙₛ(t) is the phase noise from the Tx laser.

The output signal of the local oscillator may be expressed as Equation 17.

$${E}_{LO} ( t ) = \sqrt{{P}_{LO}} {e}^{j ( {ω}_{LO} t + {φ}_{LO} )} \cdot {e}^{j {φ}_{{n}_{LO}} ( t )} \qquad [ Equation 17 ]$$

In Equation 17, P_{LO}, w_{LO}, φ_{LO} are the power, frequency, and phase of the output signal of the local oscillator, and φ_{nLO}(t) is the phase noise from the local oscillator laser.

Then, the output of the 90-degree hybrid may be composed of four signals as in Equation 18.

$$[ \begin{matrix}{E}_{{out}_{1}} ( t ) \\ {E}_{{out}_{2}} ( t ) \\ {E}_{{out}_{3}} ( t ) \\ {E}_{{out}_{4}} ( t )\end{matrix} ] = \frac{1}{2} \cdot [ \begin{matrix}{E}_{s} ( t ) + {E}_{LO} ( t ) \\ {E}_{s} ( t ) + {jE}_{LO} ( t ) \\ {E}_{s} ( t ) - {E}_{LO} ( t ) \\ {E}_{s} ( t ) - {jE}_{LO} ( t )\end{matrix} ] \qquad [ Equation 18 ]$$

FIG. 16 shows another example of a coherent detector to which the second implementation of the present disclosure is applied.

Referring to FIG. 16, four signals according to Equation 18 are divided into Eₒᵤₜ₁(t) and ELA(t), Eₒᵤₜ₃(t) and Eₒᵤₜ₂(t) and applied to two balanced PDs.

Then, the photocurrent for in-phase may be expressed by Equation 19.

$${I}_{I} ( t ) = R \sqrt{{P}_{S} {P}_{LO}} \cdot a ( t ) \cdot cos ( {ω}_{IF} t + φ ( t ) + {φ}_{n} ( t ) ) \qquad [ Equation 19 ]$$

In Equation 19, R is the responsivity of each PD, w_{IF} is the intermediate frequency corresponding to the difference between the received signal and the carrier frequency of the local oscillator, and φₙ(t) is the residual phase noise component.

In the same way, the photocurrent for quadrature may be expressed as Equation 20.

$${I}_{Q} ( t ) = R \sqrt{{P}_{S} {P}_{LO}} \cdot a ( t ) \cdot sin ( {ω}_{IF} t + φ ( t ) + {φ}_{n} ( t ) ) \qquad [ Equation 20 ]$$

Therefore, a complex signal may be reconstructed through the in-phase element and the quadrature element.

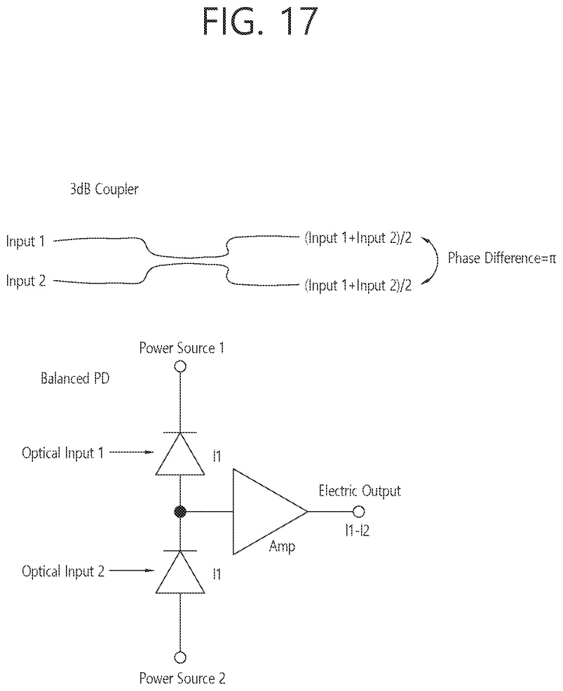

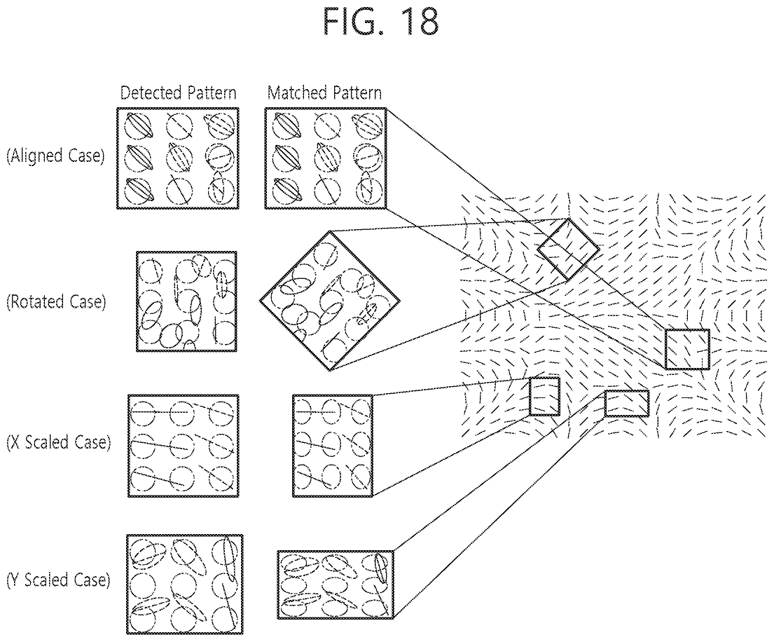

FIG. 17 shows an example of a 3 dB coupler and a balanced PD to which the second implementation of the present disclosure is applied.

Among the elements constituting the coherent detector, the 3 dB coupler is a device that receives two optical sources as inputs, mixes them, and then splits the sources at a ratio of 50:50, and may create a phase difference in the output source according to the design of the 3 dB coupler. The balanced PD is a device that outputs only the current corresponding to the current difference of the optical signals input from each of the two PDs.

Referring to FIG. 17, the paths corresponding to polarization filters 0 and 1 acquire in-phase information and quadrature information by the coherent detector, but the paths corresponding to polarization filters 2 and 3 acquire only the signal magnitude information by the PD. Therefore, the power measured by the detector of each path is measured in a total of six magnitudes as P₀⁽¹⁾, P₀^{(Q)}, P₁^{(I)}, P₁^{(Q)}, P₂, and P₃, and among these, P₀⁽¹⁾, P₀^{(Q)}, P₁^{(I)}, and P₁^{(Q)} are combined and applied to the ADC of the digital signal processor. Each measured magnitude may be expressed by Equation 21 according to the characteristics of the polarizer through which each has passed.

$${P}_{0}^{( I )} = {\vert {E}_{x}^{( I )} \vert}^{2} \\ {P}_{0}^{( Q )} = {\vert {E}_{x}^{( Q )} \vert}^{2} \\ {P}_{1}^{( I )} = {\vert {E}_{y}^{( I )} \vert}^{2} \\ {P}_{2}^{( Q )} = {\vert {E}_{y}^{( Q )} \vert}^{2} \\ {P}_{2} = \frac{1}{2} ( {E}_{x}^{2} + {E}_{y}^{2} + 2 {E}_{x} {E}_{y} cos δ ) \\ {P}_{3} = \frac{1}{2} ( {E}_{x}^{2} + {E}_{y}^{2} + 2 {E}_{x} {E}_{y} sin δ ) \qquad [ Equation 21 ]$$

Therefore, the Stokes parameter may be obtained as in Equation 22 through the output power of Equation 21.

$${S}_{0} = {P}_{0}^{( I )} + {P}_{0}^{( Q )} + {P}_{1}^{( I )} + {P}_{1}^{( Q )} \\ {S}_{1} = {P}_{0}^{( I )} + {P}_{0}^{( Q )} - {P}_{1}^{( I )} - {P}_{1}^{( Q )} \\ {S}_{2} = 2 {P}_{2} - ( {P}_{0}^{( I )} + {P}_{0}^{( Q )} - {P}_{1}^{( I )} - {P}_{1}^{( Q )} ) \\ {S}_{3} = 2 {P}_{3} - ( {P}_{0}^{( I )} + {P}_{0}^{( Q )} - {P}_{1}^{( I )} - {P}_{1}^{( Q )} ) \qquad [ Equation 22 ]$$

The polarization state may be obtained through the above-obtained Stokes parameters.

The components for the complex signal transmitted through the IP beam are divided into the in-phase signal and the quadrature signal, but since they are common to the x-axis component and the y-axis component that constitute the polarization, they may be expressed as |S_{c}⁽²⁾|²=Eₛ^{(I)}Eₛ^{(I)*}, or may be expressed as |S_{c}^{(Q)}|²=Eₛ^{(Q)}Eₛ^{(Q)}*. Here, Eₛ⁽¹⁾ and E_{S}^{(Q)} are the received signals converted into amplitude signals through the PD and TIA. Since the signals are equally divided in the coupler, Eₓ⁽¹⁾, Eₓ^{(Q)} and E_{y}^{(I)}, E_{y}^{(Q)} for reconstructing Eₛ^{(I)} and Eₛ^{(Q)}, respectively, become ½ in terms of power, and may be expressed as |S_{c}|²=2|Eₓ|²+2|E_{y}|². Therefore, the power of the complex signal |S_{c}(C)|²=2(P₀^{(I)}+P₁^{(I)}+2j(P₀^{(Q)}+P₁^{(Q)}) may be obtained through the above output power.

In the above, P₀⁽¹⁾, P₀^{(Q)}, P₁⁽¹⁾, P₁^{(Q)}, P₂ and P₃ may be obtained individually for each photodetector of the coherent detector array and the photodetector array. In this case, the output power may be obtained as many as the number of photodetectors constituting the coherent detector array and the photodetector array. For example, for a coherent detector array and a photodetector array including M² photodetectors, the individually measured output powers for the photodetectors may be expressed as P₀^{(I)}(i,j), P₀^{(Q)}(i,j), P₁^{(I)}(i,j), P₁^{(Q)}(i,j), P₂(i,j), P₃(i,j)(i,j=1, . . . , M). Accordingly, the Stokes parameters may be measured for each individual photodetector index (i,j).

Returning to FIG. 13, for each photodetector index (i,j), if the Stokes vector S(i,j)=[s₀(i,j), s₁(i,j), s₂(i,j), s₃(i,j)], which is composed of each Stokes parameter obtained as described above, the IP pattern demodulator derives the IP pattern index L by measuring the Euclidean distance with each modulation state Pₜ for the spatial index (i,j).

For example, when the elements of the IP pattern matrix P_{f} are p_{i,j}^{(f)}, and the polarization state information expressed as a Stokes vector is used, the Euclidean distance between p_{i,j}^{(l)} of each spatial index (i,j) and the S(i,j) obtained above may be measured by the following Equation 23.

$$arg {min}_{l} {\sum }_{i = 1}^{M} {\sum }_{j = 1}^{M} \sqrt{{\vert {p}_{i , j}^{( i )} - S ( i , j ) \vert}^{2}} , for l = 1 , … , N \qquad [ Equation 23 ]$$

The IP pattern demodulator may measure the Euclidean distance for all spatial indices according to Equation 23 and add them to demodulate the IP pattern index C having the minimum distance.

The receiver may perform de-mapping in the N-IPM mapping table described above in the first implementation of the present disclosure based on the derived IP pattern index f to obtain bit stream information.

The above-described IP pattern demodulation may be performed based on the IP pattern matrix agreed between the transmitter and the receiver. Therefore, when the IP pattern matrix size is M², if the size of the spatial index (i,j) measured by the polarization state detector is larger or smaller than M², IP pattern demodulation may be performed for the size M² through an implementation technique such as interpolation or compression.

In the above, the IP pattern may be scaled or rotated due to misalignment or distance difference between the transmitter and the receiver.

FIG. 18 shows an example of demodulating an adjusted or rotated IP pattern to which the second implementation of the present disclosure is applied.

Referring to FIG. 18, when the transmitter and the receiver are aligned and facing each other (Aligned case), the pattern detected from the IP pattern may be searched for directly. On the other hand, when the transmitter and the receiver are facing each other but the receiver is rotated (Rotated cased), the pattern detected from the IP pattern may be searched for by considering the rotation. In addition, when the axis where the transmitter and the receiver face each other is the Z-axis and the receiver is tilted to the X-axis or Y-axis, the pattern detected from the receiver is scaled to the X-axis or Y-axis (X Scaled case or Y Scaled case), so the detected pattern may be searched for by considering the adjustment of the X-axis or Y-axis in the IP pattern. In addition, since the adjustment to the X-axis or Y-axis may occur depending on the distance between the transmitter and the receiver, the detected pattern may be searched for by considering the adjustment of the X-axis or Y-axis in the IP pattern Performance optimization for adjustment and rotation may be implemented differently depending on the implementation technology.

### d) Digital Signal Processor

Returning to FIG. 12, the digital signal processor is composed of an Analog-to-Digital Converter (ADC) that converts an electrical analog signal converted from an optical detector into a digital signal, a demodulator that demodulates a digital signal modulated and transmitted through a conventional modulation scheme, a data combining unit that combines bit stream 1 demodulated from N-IPM and bit stream 2 demodulated by the demodulator, and a decoder that performs decoding on the combined bit stream information. The digital signal processor decodes the signal transmitted from the transmitter to obtain data.

The ADC converts an electrical analog signal converted from a polarization state detector into a digital signal. The ADC may convert an analog signal into a digital signal through an electrical filter and down-sampling. The ADC may perform conversion on each of the X-polarization signal and the Y-polarization signal. In the case of coherent transmission and detection scheme that performs IQ modulation for each polarization signal, the ADC may perform separate conversion for each polarization signal by dividing each polarization signal into an in-phase signal and a quadrature signal. The converted digital signal is applied to the demodulator.

The demodulator performs conventional demodulation on the digital signal converted by the ADC to obtain matching coded bits. The demodulator is configured according to the modulation scheme used in the modulator, and the configuration of the demodulator may vary depending on the IM/DD scheme and the phase-based modulation scheme. In addition, for each scheme, the configuration of the demodulator may vary depending on the single-carrier scheme and the multi-carrier scheme.

The data combining unit combines the bit stream 1 information demodulated from the N-IPM and the bit stream 2 demodulated through the conventional demodulation scheme. If the N-IPM is used alone without the conventional demodulation scheme, it is obvious that the N-IPM may operate alone without a device for conventional demodulation.

The decoder decodes the coded bit stream received from the transmitter to obtain digital data. The configuration of the decoder may vary depending on the channel coding scheme used in the encoder of the transmitter.

### 3. Third Implementation: Differential Information Based Inhomogeneous Polarization Pattern Acquisition

According to the third implementation of the present disclosure, in the N-IPM system according to the first and second implementations of the present disclosure described above, a pre-agreed homogeneous polarization pattern may be used as a reference signal to reflect polarization distortion according to the channel, thereby removing the channel effect in the demodulation of the N-IPM. At this time, the reference signal may be transmitted periodically based on the coherent time for the polarization distortion.

That is, the N-IPM system according to the first and second implementations of the present disclosure may be operated in a difference modulation scheme using a pre-agreed homogeneous polarization pattern as a reference signal.

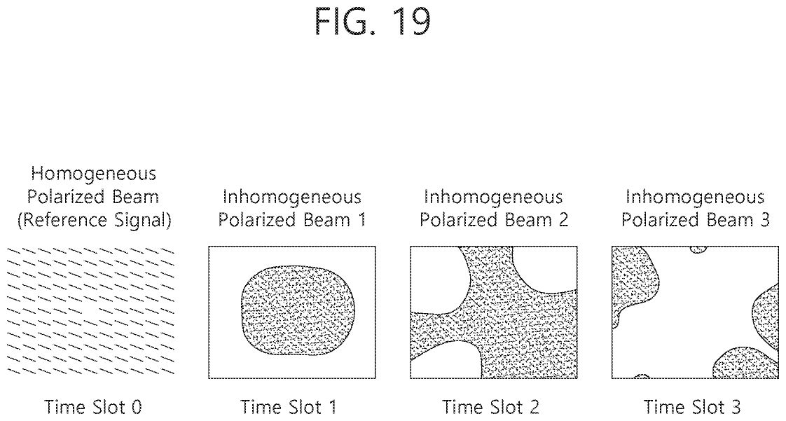

FIG. 19 shows an example of acquiring an inhomogeneous polarization pattern based on difference information to which the third implementation of the present disclosure is applied.

Referring to FIG. 19, the transmitting end transmits a homogeneous polarization pattern corresponding to a reference signal in time slot 0. The transmitting end transmits IP beams 1 to 3, respectively, using a difference modulation-based N-IPM system in time slots 1 to 3. For example, the polarization difference for each spatial index (i,j) between the beams transmitted in time slot 0 and time slot 1 may be an IP pattern index specified in N-IPM. In the same way, the polarization difference for each spatial index (i,j) between the beams transmitted in time slot 1 and time slot 2, and time slot 2 and time slot 3 may be an IP pattern index specified in N-IPM.

The receiving end measures a homogeneous polarization pattern pre-agreed in time slot 0. The receiving end measures the polarization for each spatial index (i,j) of IP beam 1 in time slot 1, and then measures the difference from the polarization for each spatial index (i,j) measured in time slot 0, thereby deriving an IP pattern index. The receiving end performs demodulation based on the derived IP pattern index. The polarization difference for each spatial index (i,j) between time slot 1 and time slot 2, and time slot 2 and time slot 3 may also be measured in the same way, and the receiving end performs demodulation of the IP pattern index accordingly.

The present disclosure can have various advantageous effects.

For example, a novel modulation scheme can be provided that utilizes wavefront spatial characteristics in LOS OWC environments utilizing narrow beams.

For example, by utilizing spatial dimensions in LOS environments, the data rate of communications can be increased.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

What is claimed is:

1. A method performed by a transmitting end in a wireless communication system, the method comprising:
generating a plurality of inhomogeneous polarization patterns based on superposition of polarization;
mapping a modulation state and an information bit for each of the plurality of inhomogeneous polarization patterns;
modulating a signal based on one inhomogeneous polarization pattern from among the plurality of inhomogeneous polarization patterns; and
transmitting the modulated signal to a receiving end.

2. The method of claim 1, wherein each of the plurality of inhomogeneous polarization patterns is generated based on a type of basis for the superposition of polarization, an amplitude of the basis, an initial phase of the basis, and a Laguerre Gaussian (LG) beam order of the basis.

3. The method of claim 2, wherein each of the plurality of inhomogeneous polarization patterns is generated by an inhomogeneous polarization modulator of the transmitting end, and
wherein the type of the basis for the superposition of polarization, the amplitude of the basis, the initial phase of the basis, and the LG beam order of the basis are provided to the inhomogeneous polarization modulator of the transmitting end by an Inhomogeneous Polarization (IP) pattern controller of the transmitting end.

4. The method of claim 1, wherein a number of the plurality of inhomogeneous polarization patterns is N, and
wherein a length of the information bit is B=log₂N.

5. The method of claim 1, wherein each of the plurality of inhomogeneous polarization patterns is expressed by an inhomogeneous polarization pattern matrix.

6. The method of claim 1, wherein the inhomogeneous polarization pattern matrix is determined by minimizing a similarity between patterns.

7. The method of claim 1, wherein the plurality of inhomogeneous polarization patterns is generated based on a difference from a homogeneous polarization pattern.

8. The method of claim 1, wherein mapping of the modulation state and the information bit for each of the plurality of inhomogeneous polarization patterns is performed by an IP pattern controller of the transmitting end.

9. The method of claim 1, wherein information related to mapping of the modulation state and the information bit for each of the plurality of inhomogeneous polarization patterns is pre-configured between the transmitting and the receiving end.

10. The method of claim 9, wherein the information related to the mapping is expressed by a mapping table.

11. The method of claim 1, wherein the modulated signal is transmitted by being mixed with an analog signal modulated by a conventional modulation method.

12. A method performed by a receiving end in a wireless communication system, the method comprising:
receiving a modulated signal from a transmitting end;
determining one inhomogeneous polarization pattern from among a plurality of inhomogeneous polarization patterns based on a polarization measurement of the modulated signal;
determining an information bit mapped to the one inhomogeneous polarization pattern; and
demodulating the modulated signal based on a modulation state mapped to the information bit.

13. The method of claim 12, wherein determining of the one inhomogeneous polarization pattern is performed by a polarization state detector of the receiving end.

14. The method of claim 13, wherein the polarization state detector comprises at least one polarization filter and at least one photo detector array, and
wherein the polarization measurement is performed based on a power output by an intensity-modulated signal passing through the at least one polarization filter and the at least one photo detector array.

15. The method of claim 13, wherein the polarization state detector comprises at least one polarization filter and at least one coherent detector array, and
wherein the polarization measurement is performed based on a power output by an in-phase and quadrature-modulated complex signal passing through the at least one polarization filter and the at least one coherent detector array.

16. The method of claim 15, wherein the at least one coherent detector array comprises a 3 dB coupler and a balanced optical detector.

17. The method of claim 12, wherein the one inhomogeneous polarization pattern is determined based on a Euclidean distance between each spatial index of an inhomogeneous polarization pattern and a Stokes parameter obtained based on the polarization measurement.

18. The method of claim 12, wherein the plurality of inhomogeneous polarization patterns is based on a difference from a homogeneous polarization pattern.

19. The method of claim 12, wherein the demodulated signal is combined with a digital signal demodulated by a conventional demodulation method and finally decoded.
